(19) United States
(12) Patent Application Publication
(10) Pub. No.: US 2004/0010419 A1
(43) Pub. Date: Jan. 15, 2004

(54) Method and apparatus for facilitating acquistion of prospective payoff information on an existing loan account

(76) Inventor: Timothy John Sinnott, Fort Pierce, FL (US)

Correspondence Address: Timothy J. Sinnott, 3115 N. Indoam River Dr., Fort Pierce, FL, 34946, US

(21) Appl. No.: 10/196,604

(22) Filed: Jul. 15, 2002

(51) Int. Cl. G06F 17/60

(52) U.S. Cl. 705/2; 705/40

(57) ABSTRACT

A method and apparatus for facilitating acquisition of prospective payoff information on an existing loan account is disclosed. In a preferred embodiment, a stand-alone computer system enables a user to conveniently create, store, print and manage payoff-statement requests. In another preferred embodiment, a central controller connected to the Internet enables a remote user to create, store, and manage payoff-statement requests, and furthermore enables the user to transmit the requests to a fax-based loan servicer and receive resultant reply payoff-statements from the loan servicer. The request is transmitted by email to an email-to-fax service, which then faxes the request to the loan servicer. The loan servicer then produces a payoff-statement and, as instructed by the request, faxes it to a fax number of a fax-to-email service. The fax-to-email service converts the fax to an email message including an image of the fax, and text from the fax, generated by OCR (Optical Character Recognition), and sends the email to the central controller. The controller then uses the OCR-generated text to determine the particular user to associate with the request, and then presents the payoff-statement to the user for viewing. A plurality of users is enabled to share payoff-statement information. Information is stored and made available to the user for later retrieval and analysis. A directory of loan servicers and their electronic addresses is accumulated for convenient lookup.

### INCORPORATION-BY-REFERENCE

A computer program listing appendix is hereby incorporated into this document. The computer program listing is contained on a CD-R compact disk, as the following single file:

| Filename: | Program_Listing_Sinnott.txt |
|---|---|
| File Creation Date: | Jul. 9, 2002 |
| File Size: | 1,353 KB |
| Disk creation Date: | Jul. 9, 2002 |

The CD-R is IBM-PC format.

The file is MS-Windows compatible ASCII.

### FIELD OF THE INVENTION

The present invention relates generally to methods and apparatuses for computer-based acquisition of financial information.

### BACKGROUND OF THE INVENTION

Conventionally, a debtor preparing to payoff a mortgage loan or unsecured loan held by a creditor needs to know the exact funds amount required as of a given payoff date. Typically the required amount will comprise principal, accrued interest, and such items as prepayment penalties, insurance, uncollected late fees, recording fees, statement fees, or other amounts.

Typically, the debtor contacts the creditor and requests an itemized statement of the amount required. The itemized statement is often referred to as a payoff-statement. The creditor will then make the calculations and furnish to the debtor a written loan payoff-statement showing the itemized total amount required as of a given date. A per diem amount is usually also stated so that, if necessary, the required amount can be adjusted over a range of days by the debtor. The payoff-statement typically includes a break down of the required amount into principal, interest, fees, or other components.

Often, the debtor doesn't contact the creditor directly, but instead contacts a loan servicing company that administers the loan account on behalf of the creditor. And often the request is made, not by the debtor in person, but by an escrow agent or other party acting on behalf of the debtor. Sometimes the other party is another lender wanting to make a new loan to the borrower, and thus needing to expedite a payoff of the existing loan first.

The result is that a significant portion of the commercial activity in this field (the acquisition of prospective payoff information on an existing loan account) today occurs between escrow companies and loan servicing companies, or between new loan originators and loan servicing companies, or between escrow companies and banks.

Often, the debtor is in the process of moving and selling a home. The escrow company is engaged by the debtor or another party to handle the paperwork and the closing of the sale. The escrow company typically asks the debtor to furnish the name, address and phone number of the creditor as well as the loan number on the loan's monthly payment slip. Acting on behalf of the debtor, the escrow agent then typically calls the phone number on the monthly payment slip, and obtains a fax number for submitting payoff requests.

In the conventional model, the escrow company then composes a written request for a payoff-statement, typically including in the request the debtor name and loan number. Sometimes, but often not, the escrow company will request a specific payoff date. This written request is then faxed to the loan servicer.

Then, usually within a few days, the payoff-statement department of the loan servicer calculates the payoff amounts, composes a written payoff-statement, and faxes that back to the requesting escrow agent as instructed by the request. The escrow agent then uses the received information in preparing documents for the escrow closing and for preparing a payoff check to be sent to the loan servicer.

Disadvantages of the Conventional Model

The above-described conventional model has a number of disadvantages:

(a) Often, individual debtors or inexperienced escrow agents will be unfamiliar with the concept and nature of a payoff-statement and lack the knowledge of how to compose a payoff-statement request, and what to expect. This can result in an erroneous request document being sent.

(b) Sometimes the escrow agent will fail to make a record of whether or when the request document was sent. Sometimes the agent will lose or dispose the request document itself, before or after faxing it. Sometimes disputes will arise between the requester of the payoff-statement and the loan servicer as to the details of the request. There is a need to store and retrieve the details of the request in a history accessible to the user.

(c) Sometimes a plurality of agents in an escrow company are involved in a single escrow closing. While the primary agent may know the history or status of the request, if the primary agent is out of the office, the other agents may be prevented from doing their work because of a lack of an organized system of storage and access.

(d) Sometimes the fax number to which the request was sent is erroneous or obsolete. In this situation it becomes important to somehow discover that fact as soon as possible. In the conventional model, this fact can sometimes go undiscovered for excessive lengths of time because there is no means of convenient follow-up. Also, if it is discovered that a fax has gone to the wrong number, then a new request must usually be composed, which can be time consuming.

(e) Sometimes a request is received successfully by the loan servicer, but then misplaced by the loan servicer. Thus the conventional model's lack of convenient follow-up sometimes results in costly delays that could be prevented or ameliorated if the request history were conveniently accessible.

(f) Sometimes when the loan servicer successfully prepares the payoff-statement and faxes it to the requesting escrow company, the payoff-statement can sit undiscovered on the escrow company's fax machine, and become lost among other unrelated faxes, and never get to the escrow agent that requested it. Again, the conventional model's lack of convenient follow-up results in costly delays that could be prevented or ameliorated with close follow-up.

(g) Sometimes when the payoff-statement process goes slowly, the debtor inadvertently makes an extra monthly payment to the bank after the payoff-statement has been issued. Or, if the loan is a line of credit, the debtor may take a draw on the line. Either event necessitates yet another request and another payoff-statement. Sometimes the debtor will be in a hurry and will call the escrow agent or loan servicer numerous times to inquire about the status of the payoff-statement request. These extra phone calls are inconvenient for the debtor and expensive for the escrow company and the loan servicer. There is a need for a method to expedite the payoff-statement process and, when an escrow company is involved, to keep the individual debtor closely and conveniently informed as to the payoff-statement request status and result. There is a need for a centralized system capable of being accessed by both debtor and escrow agent, and sometimes other parties, such as attorneys or real estate agents, who may have an interest in the loan payoff process.

(h) In the conventional model it's difficult for a business organization to gain an accurate perspective of the production volume and nature of created payoff-statement requests over a given time interval such as a month, quarter or year.

Needs Summarized

Accordingly, there is a need for a stand-alone system and method for facilitating the acquisition of loan payoff information that enables a user to create, store, print and manage requests for loan payoff-statements, and to analyze volumes of created requests over time intervals such as months, quarters and years.

Furthermore, there is a need for a system and method whereby a user can transmit payoff-statement requests in a convenient and organized manner.

Furthermore, there is a need for a system and method whereby a user can receive and access a reply resulting from a request in a convenient and organized manner.

Furthermore, there is a need for an automated payoff-statement request/reply system that is able to interface somehow with the conventional fax-based system prevalent in the loan service industry today.

Furthermore, there is a need for a method and centralized system capable of being used jointly by a plurality of interested parties, such as a debtor and an escrow agent, to jointly access requests and resultant replies.

The applicant is unaware of the existence of any commercially viable system or method that contains the above features and addresses the above described shortcomings of the prior art.

Objects

It is one object of the present invention to set forth a stand-alone system enabling a user to conveniently build, store, print and manage payoff-statement requests, and analyze production volumes and details of created requests over time intervals such as days or months.

Another object of the present invention is to allow a user with an Internet connection or fax modem to conveniently transmit a payoff-statement request.

Yet another object of the present invention is to set forth a system and method for enabling a user to receive a payoff-statement reply.

A further object of the invention is to set forth a method and apparatus by which a user can conveniently manage payoff-statement requests, and their resultant replies, via a browser connection to the Internet, notwithstanding the fact that a large portion of loan servicers in existence today utilize the conventional faxed-based model of receiving requests and sending replies by fax over the Public Switched Telephone Network.

These and other objects of the invention will be apparent to those skilled in the art from the following detailed description of the invention, the accompanying drawings and the appended claims.

### SUMMARY OF THE INVENTION

Briefly, the present invention provides a method and apparatus for facilitating acquisition of prospective payoff information on an existing loan account.

In a preferred embodiment, a stand-alone computer system enables a user to conveniently create, store, print and manage payoff-statement requests.

In another preferred embodiment of this invention, a central controller connected to the Internet enables a remote user to create, store, and manage payoff-statement requests, and furthermore enables the user to transmit the requests to a loan servicer and receive resultant reply payoff-statements from the loan servicer. In this embodiment, the user logs onto the central controller via a browser and inputs information about the requester of the payoff-statement, for example the requester name and email address. The user inputs a loan servicer identifier, such as loan servicer company name, and a loan account identifying information, such as an account number and debtor name. The user then inputs a fax number for the loan servicer. The central controller stores these inputs and builds a payoff-statement request document. The central controller then adds a special return fax number and insinuates a code-delimited request identification number (request ID) into the request document in a manner such that the loan servicer will likely copy it into the payoff-statement. An example of coded delimiters would be “RQR” as a prefix and “QT” as a suffix, these character strings chosen as unlikely to occur naturally. The special return fax number points to a fax-to-email service. The code-delimited request ID will be used to extract the request ID from any payoff-statement resulting from this request. The controller then transmits the request document by email to an email-to-fax service, which converts it to a fax and forwards the fax to the loan servicer. The loan servicer processes the request, which may take a few seconds or a few days, and outputs a payoff-statement carrying the code-delimited request ID. The loan servicer faxes the payoff-statement, per the request, to the special return fax number, which points to a fax-to-email service. The faxed payoff-statement is thus received at the fax-to-email service addressed to the special fax number, which the fax-to-email service knows to associate with the central controller. The fax-to-email service then converts the faxed payoff-statement to a tiff (Tag Image File Format) file, and further generates a text version of the .tiff image using OCR (Optical Character Recognition). The fax-to-email service then sends an email, with the OCR-generated text in its body, and the tiff file as an attachment, to the central controller. The central controller receives the email and examines the OCR text, looking for the coded delimiters, “RQR” and “QT”, used earlier for insinuating the request ID into the request document. It extracts the number it finds between the two delimiters, that number being the request ID. The controller then uses the request ID to associate the reply with its causative request and thus is able to determine the identity of the requester and user. The controller stores the received .tiff file and then sends an email alert to the requester stating that the payoff-statement has been received from the loan servicer, and is available for viewing. The user logs back onto the controller and accesses a history of the request including the reply. The user is enabled to view the tiff image of the payoff-statement, to zoom in or out, and to print it. To the naked eye, the printed payoff-statement appears exactly as though it were faxed from the loan servicer and received by the user by a conventional fax machine, and with the present invention, the user is able to track, monitor, document and manage the whole process, end to end, in a convenient manner, from a central location.

In another embodiment, the loan servicer element is a Web Service and the central controller builds the payoff-statement request document using XML (Extensible Markup Language) formatting to provide enhanced data transmission. The controller sends the request document directly to the loan servicer as part of a SOAP (Simple Object Access Protocol) procedure invocation of the loan servicer Web Service, which responds by returning an XML formatted payoff-statement directly to the controller. The XML payoff-statement is then associated with its requester, transformed into a user-friendly payoff-statement using an XSL (Extensible Style Sheet Language) stylesheet transformation, and displayed to the user. This embodiment requires that the user and the loan servicer agree on a common XML structure specific to payoff-statements. In this sense, a major benefit of the present invention is that its use will encourage and stimulate construction and acceptance of common open XML standards for payoff-statements in the industry.

In another embodiment of this invention, a user is enabled to conveniently share access to payoff-statement requests and/or resultant replies with other interested parties, for example escrow agents, attorneys, or loan account debtors.

### BRIEF DESCRIPTION OF THE DRAWINGS

FIG. 1 illustrates simplified examples of a conventional payoff-statement request and payoff-statement drawn by me from my knowledge of conventional industry practices.

FIG. 2 is a schematic diagram of a preferred embodiment of the invented apparatus for facilitating acquisition of prospective loan payoff information on an existing loan account.

FIG. 3(a) and FIG. 3(b) together are a flowchart illustrating a preferred embodiment of the invented method for facilitating acquisition of prospective payoff information on an existing loan account.

FIG. 4 illustrates an embodiment of the invented method of associating a payoff-statement reply with its causative payoff-statement request.

FIG. 5 is a variation of the system of FIG. 2, but in which a second fax modem is used, instead of the email-to-fax service and fax-to-email service.

FIG. 6 is a variation of the system of FIG. 2, but in which the request is transmitted over the Internet directly from the central controller to the loan servicer, and the reply is transmitted over the Internet directly from the loan servicer to the central controller.

FIG. 7 is a general schematic diagram of the invented apparatus as a stand-alone computer for the building, storing, outputting, and management of payoff-statement requests.

FIG. 8 is a flowchart illustrating an embodiment of the invented method for using a stand-alone computer for the building, storing, outputting, and management of payoff-statement requests.

### DETAILED DESCRIPTION OF THE INVENTION

Terms for Discussions

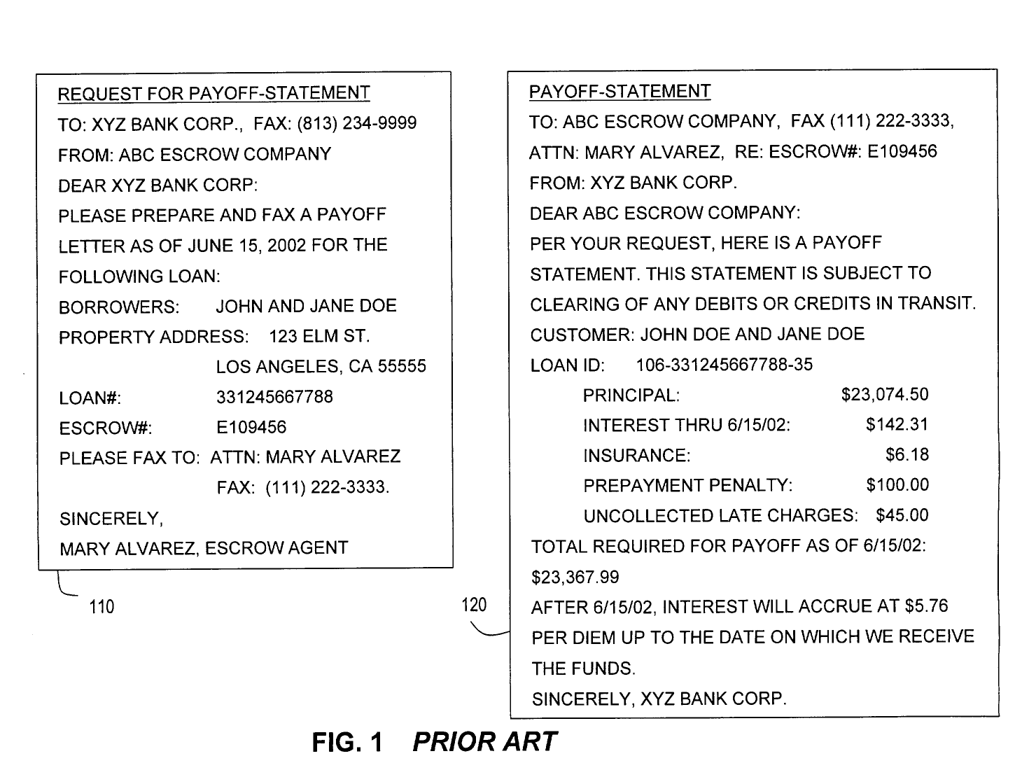

This is a good point at which to clarify two terms that will be used repeatedly in the following discussions. Two important concepts are (a) a payoff-statement request, and (b) a resultant payoff-statement resulting from the request. A simplified example of each is illustrated in FIG. 1.

In the following discussions, payoff-statement request is sometimes called a “payoff-statement request document”, or simply a “request”. A payoff-statement, on the other hand, may be called a “payoff-statement reply”, or a “payoff-statement document”, or simply a “reply”. To simplify things and make reading easier, the solitary words “request” and “reply” will always mean (a) and (b), respectively. In other words, a reply results from a request.

Discussion of FIG. 1

As mentioned above, FIG. 1 illustrates a simplified, conventional payoff-statement request document 110 and a simplified, conventional payoff-statement reply document 120. These illustrations were made by me solely from my knowledge of typical industry conventions in order to give the reader some background.

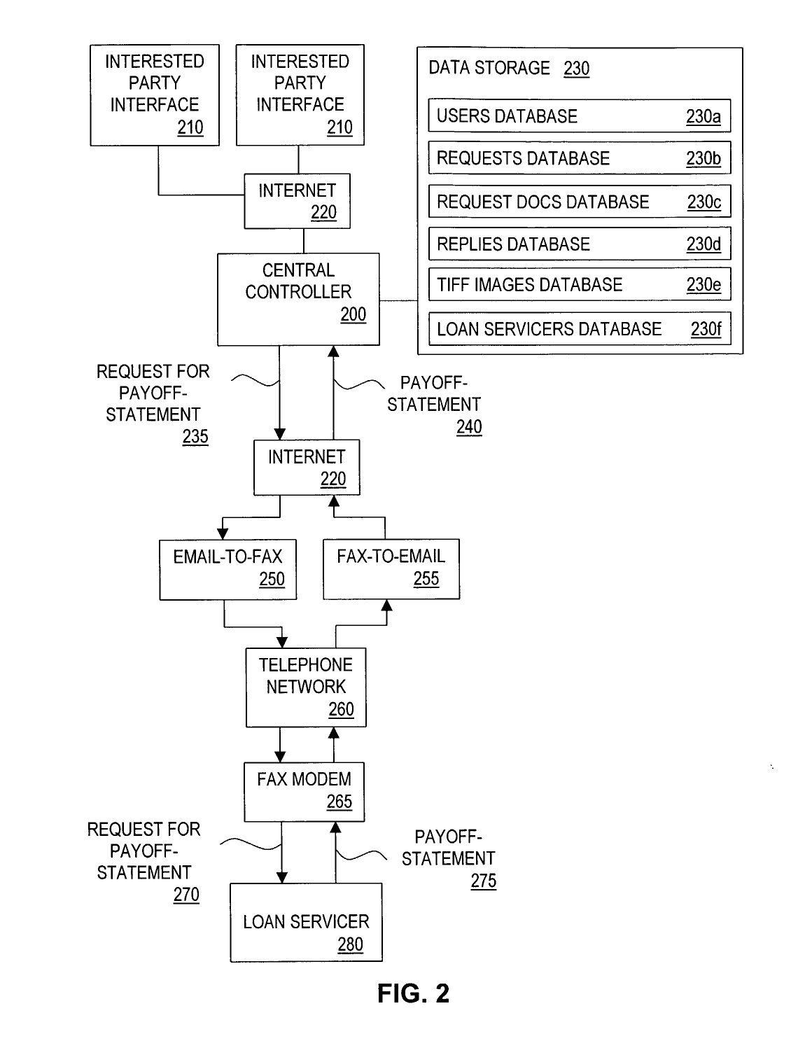

Discussion of FIG. 2

A system constructed in accordance with a preferred embodiment of the present invention is schematically shown in FIG. 2.

In this embodiment, the present invention includes interested party interface 210. It is a conventional computer, running an operating system, such as MICROSOFT WINDOWS 2000 PROFESSIONAL, an office utility program, such as MICROSOFT OFFICE XP, a browser program, such as MICROSOFT INTERNET EXPLORER 6.0, and an email client program, such as MICROSOFT OUTLOOK 2002. It is operatively connected with the Internet 220. It should be understood that it is intended to be within the scope of the present invention that interface 210 is meant to broadly include other computers including, for example terminals, system servers, mobile or handheld computing devices, or business-to-business message queuing systems.

Central controller 200 is a conventional computer operatively connected with the Internet 220 and data storage 230. It is running an operating system (such as MICROSOFT WINDOWS 2000 PROFESSIONAL with MICROSOFT.NET FRAMEWORK), a web server program (for example MICROSOFT INTERNET INFORMATION SERVER 5.0), an office utility program, such as MICROSOFT OFFICE XP, an email program (such as MICROSOFT OUTLOOK 2002), and a database server program (for example MICROSOFT SQL SERVER 2000). Central controller 200 is also executing software as follows: a web application program (for example one written in MICROSOFT'S ASP.NET, VB.NET and ADO.NET), and a program for processing of inbound email and email attachments, including .tiff images (for example one written in MICROSOFT VB.NET).

It should be understood that it is intended to be within the scope of the present invention that the software executing on the central controller could alternatively comprise products or brands other than these examples mentioned above. For example the use of NETSCAPE NAVIGATOR rather than MICROSOFT INTERNET EXPLORER. It should also be understood that the term “central controller” is meant to be broadly construed to include a conventional computer, a system server, or a plurality computers or servers.

Data storage 230 is utilized by the database server program executing on central controller 200. A database stored on data storage 230 comprises a group of databases, tables or lists, for example these databases: users, requests, request does, replies, tiff images and loan servicers.

Request for payoff-statement 235 is generated by central controller 200, based on user input. In this embodiment of the present invention, request for payoff-statement 235 resembles the conventional request document 110 of FIG. 1. However request 235 has a return fax number that will eventually cause the resultant reply payoff-statement to be routed back to central controller 200. It also has a coded attention phrase embedded in it so that upon eventual receipt by the central controller of the resultant reply, the reply can be associated with the causative request and thus routed to the appropriate, original requesting user. Also, request 235 is electronic rather than on paper.

Before transmitting the payoff-statement request 235, the central controller stores a record of the request, including the user input, in data storage 230. In one embodiment, the request document is built by the central controller, using an ASP.NET web page as a template, and using the webrequest and webresponse objects of ASP.NET to pull and save the HTML generated by the template to an .htm file and to request does database 230c. This results in a richly formatted request document. In another embodiment, the central controller builds the request document using simple text, saves the text to request does database 230c, and saves it as a simple .txt file. Request 235, in the form of a .htm, .doc, .txt, or other such file, is then transmitted by email to email-to-fax service 250.

Because obtaining a payoff-statement from a loan servicer typically takes several days, the user typically logs off after creating the request.

Email-to-fax 250 is a service that converts an email message to a fax message. An example of a email-to-fax service is MAXEMAIL, by Integrated Global Concepts, Inc. In this embodiment, central controller 200 sends an email with the payoff-statement request document as an attachment, in the form of a .doc, .htm, or .txt file. In the “To” line of the email message, central controller 200 places an address like this:

18005551234@maxemailsend.com, where 18005551234 is the fax number of loan servicer 280.

When this email is received by the email-to-fax service, the email-to-fax service renders out the .htm file, or other such file, and converts it to a fax and sends the fax via conventional telephone network 260 (for example, the Public Switched Telephone Network) to loan servicer 280, where it is received via fax modem 265 as a normal fax.

Loan servicer 280 is typically a bank, mortgage company, private lender, or company in the business of servicing loan accounts for a plurality of creditors. Loan servicer 280 receives the payoff-statement request 270, makes the necessary itemized payoff calculations, composes a payoff-statement, and, based on the instructions in the request 270, faxes payoff-statement 275 to the fax number specified by the request. It should be understood that the term “loan servicer” is meant to be broadly construed to include a creditor, a lender, a loan servicing company, or a device or system for processing payoff-statement requests.

The return fax number specified in request 270, and illustrated at FIG. 4 item 428, points to a unique fax number at fax-to-email service 255. An example of a fax-to-email service, sometimes called fax-receive service, is THRUFAX, provided by Onset Technology, Inc. Other examples are JFAX by J2 Global Communications, Inc., and FAX-TO-EMAIL by Dodora Unified Communications, Inc. Thus payoff-statement 275 is transmitted via facsimile over conventional telephone network 260 to fax-to-email service 255. Based on the fax number at which the incoming fax is received, fax-to-email service 255 associates the incoming fax with an account for controller 200, to which it will forward the information in the fax as described next.

Fax-to-email service 255 processes the incoming fax in the following manner: (a) It makes a .tiff file of the fax image, (b) it uses conventional optical character recognition (OCR) to create text from the fax image, (c) it places the OCR-generated text in the body of a new email message, (d) it attaches the .tiff file to the new email, and finally, (e) it sends the new email with its attachment to the email address of central controller 200. This email is illustrated as payoff-statement 240.

Central controller 200 receives payoff-statement 240 in the form of an email from fax-to-email service 255. Because the information in this payoff-statement must ultimately be delivered to the requesting user, it becomes necessary at this point to somehow associate the incoming reply with the particular causative request, which may be stored among a plurality of other requests in data storage 230. This is accomplished by extracting a unique request ID as illustrated in FIG. 4 item 425c.

It's important to realize that conventionally, most loan servicers process requests for payoff-statements in a methodical manner and each loan servicer typically uses its own format. There is no field in a typical payoff-statement format that might be called RequestId. If the payoff-statement request contained directions from an escrow agent asking that a particular RequestId be added to the payoff-statement, most high-volume loan servicers would be unable to accommodate that because their processing systems are somewhat inflexible.

Yet, to effectively route incoming payoff-statement 240, our central controller 200 needs to identify the causative request. This is accomplished as follows. During the original creation of a request, the central controller creates a unique request ID and embeds it in another, surrogate, field that is commonly handled automatically by typical loan servicer processing. Almost all loan servicers have an “attention” field in their payoff-statement formats, where they normally place a person's name. This is a good candidate for a surrogate field to hold the request ID.

In this embodiment of the present invention, a unique request ID is embedded in attention phrase 425a, b, c, d of FIG. 4. For the reader's reference, a conventional attention phrase is illustrated in FIG. 4, item 410.

Thus, payoff-statement 240, as it eventually arrives at central controller 200, carries the unique request ID embedded within.

In this embodiment of the present invention, central controller 200 extracts the embedded request ID as follows: (a) using MICROSOFT VB.NET commands to manipulate the application object of MICROSOFT OUTLOOK 2002, the central controller searches the OCR-generated text in the body of the email received from fax-to-email service 255, looking for substring 425b “RQR” (this combination of characters chosen as unlikely to occur naturally in a document) and notes its location; (b) it searches for substring 425d, “QT”, and notes its location; and (c) it extracts any substring 425c it finds between the two locations.

After extracting the embedded request ID, the central controller uses the request ID to associate the payoff-statement 240 with its causative payoff-statement request 235, a record of which is stored in data storage 230. This allows the central controller to lookup the email address of the requesting user and to send an email to alert the user, stating that a reply to the user's payoff-statement request has been received and is available for viewing.

Note—Viewing the Reply

Upon receiving the email, the user logs on using interface 210. The central controller displays to the user the record of the originating request 235 and the resultant reply payoff-statement 240.

In an embodiment of the present invention, display of the information in payoff-statement 240 to the user is accomplished in the following manner. As explained earlier, payoff-statement 240, arriving as an email message from fax-to-email service 255 comprises an email message with OCR-generated text in the body of the message, and an attached .tiff file. (.tiff stands for Tag Image File Format.) The .tiff file, remember, is an image of fax 275 sent by loan servicer 280. Upon receipt of this email, central controller 200 stored the tiff image into data storage 230. Therefore, when the user logs on and selects the request from a displayed list of requests, the central controller writes the .tiff image to a web page that it sends to the user's browser in interface 210. In this embodiment of the present invention, the user's interface is running MICROSOFT INTERNET EXPLORER 6.0, MICROSOFT OFFICE XP, MICROSOFT OUTLOOK 2002, and MICROSOFT WINDOWS 2000 PROFESSIONAL. In this embodiment, the browser allows the user to view, zoom-in, zoom-out, and print the .tiff image. (Windows 2000 and Internet Explorer 6.0 include Kodak imaging for this.) When viewed on screen or printed to paper, the resultant document appears to the naked eye as though it came by conventional fax machine directly from the loan servicer. Thus the objective is achieved in that the user is enabled to acquire prospective payoff information on an existing loan account in a convenient manner.

Note—Managing Requests

In addition to delivering the sought-after payoff information to the user, this embodiment of the present invention is advantageous in that it also enables the user to log on at any time to view a history, i.e. list, of past requests, to see which requests have received replies, to make notes, i.e., annotate, requests and replies, to re-send requests, to share and exchange request/reply information with co-workers and other interested parties, and generally, to manage the acquisition of prospective payoff information on existing loan accounts in a convenient and effective manner. When disputes arise between a loan servicer and requester, the invention enables the user to retrieve the exact details of a given request from data storage 230. Additionally, the apparatus allows the user to view production volumes for requests created and replies received over a given interval of time such as day, month, or year. The user is enabled to sort, group and count the stored data so as to gain valuable business insights.

Note—Sharing Information

After the user initially inputs information via interface 210 for creation of request 235, central controller displays a unique request ID for the new request to the user. If the user wishes to share the information with another interested party, the user tells the request ID to the other interested party. The other party then logs onto the central controller via interface 210, inputs the request ID, and is able to view the information. Some examples of interested parties are debtors or signatories on the loan, escrow agents, attorneys, and real estate agents.

In some situations, loan servicers require that they receive permission from the debtor before releasing information to another party. As another example of information sharing and exchange, one embodiment the invention allows the debtor to give permission to the loan servicer by enabling the debtor to input the permission remotely, the permission then being transmitted with the payoff-statement request to the loan servicer. One permission mechanism enables the debtor to click a screen, choosing either “I give” or “I refuse” permission, this information then being conveyed to the loan servicer with the request.

Note—Collecting Addresses

When reply 240 is processed by central controller 200, it is associated with its causative request 235, a record of which was stored in requests database 230b. The electronic network address used for transmitting the request is then deemed verified, and it is then accumulated into loan servicers database 230f. The purpose of this database is to act as an electronic directory whereby users can look up the electronic network address, such as a fax number or an email address, for a given loan servicer.

Note—Databases

Users database 230a tracks all users, with fields such as user ID, email address, and name. Requests database 230b tracks all requests with fields such as request ID, creation time, loan servicer name, loan servicer fax number, loan servicer email address, user ID.

Request docs database 230c stores a copy of the built request document with fields such as request doc id, request id, and html. This field, html, stores the complete HTML text definition of the request document so that the complete document can be viewed by browser, or printed, at a later time in its original format. The HTML text stored in this field is the same HTML text that is sent by central controller 200 to email-to-fax service 250 via email as an attached .htm file.

Replies database 230d tracks all the incoming replies 240, using fields such as reply id, creation time, email subject, email body, attached file name, and request id OCR.

Tiff images database 230e tracks the .tiff images attached to arriving replies 240, using fields such as tiff image id, reply id, and tif image. One embodiment of the present invention stores the .tif image in this field as a BLOB (binary large object).

For each arriving reply, loan servicers database 230f accumulates the electronic network address found in the associated causative request, and marks it verified, thereby accumulating a directory of verified electronic addresses of loan servicers. This allows central controller 200 to provide a convenient directory for looking up electronic addresses of loan servicers. These databases are stored in data storage 230.

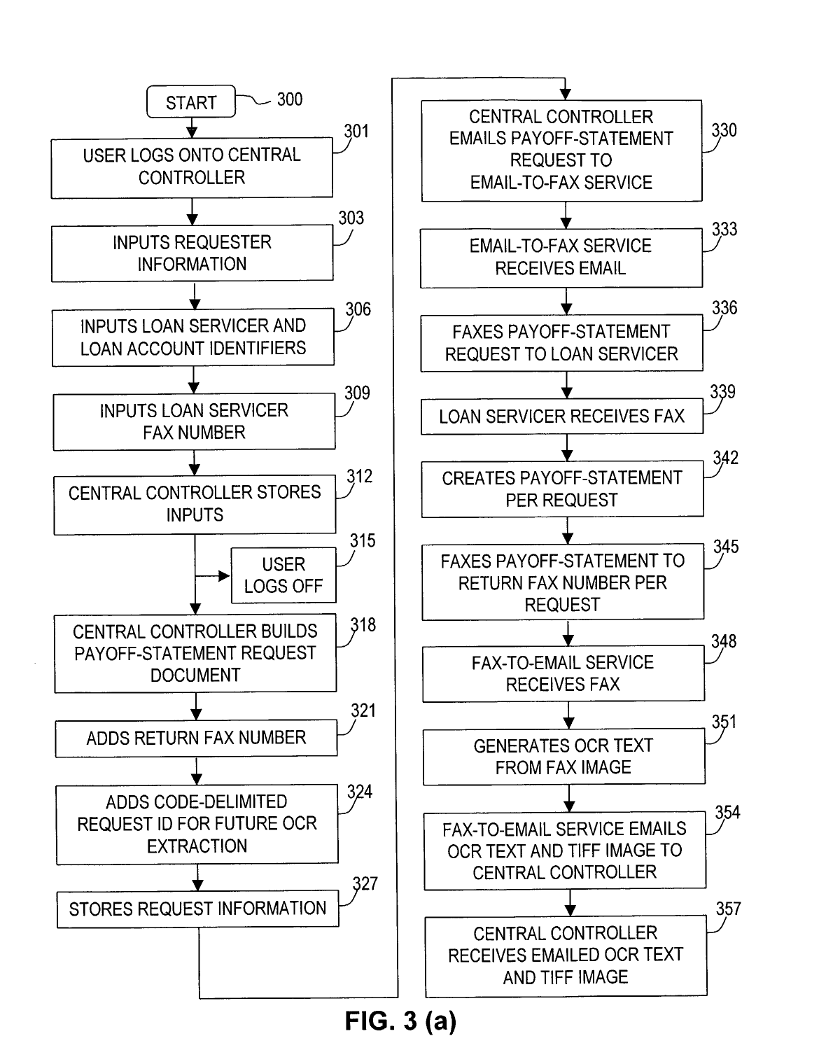

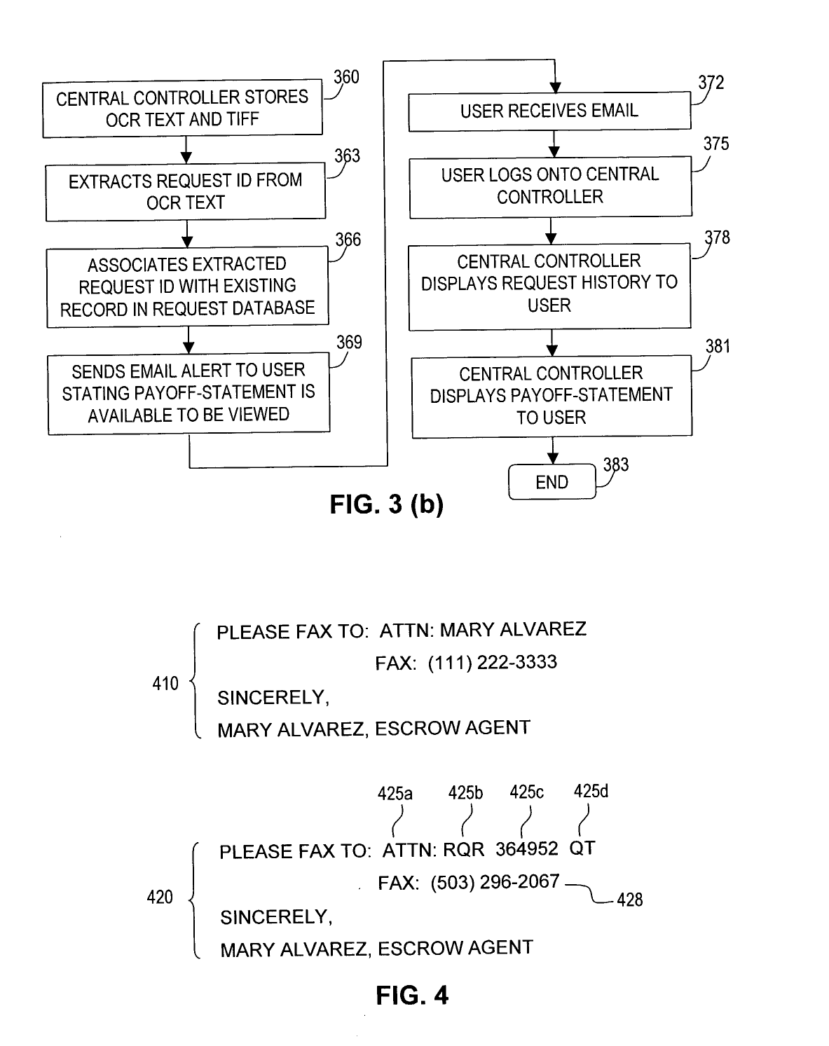

Discussion of FIG. 3

A method embodying the present invention is illustrated in FIGS. 3(a) and 3(b) as a process, or series of sequential steps. The method illustrated in FIGS. 3(a) and 3(b) is directly related to the system illustrated in FIG. 2. Referring to FIG. 3(a) and FIG. 2 collectively, the method may be seen to begin at 300. At 301, the user logs onto central controller 200 via interface 210 over network 220. At 303, the user inputs the name and company of the requester (usually the user) and the user's email address. The user here is, for example, a debtor, an escrow agent, or a new loan originator loan officer. In another embodiment, at 810 the user also is enabled to input a specific date for payoff and special verbal instructions.

At 306, the user inputs loan servicer and loan account identifier information. As used here, the term “loan servicer” is intended to be broadly construed to mean a party or system servicing the loan account, for example a creditor, a lender, a loan servicing company, or a loan servicing computer system. Examples of a loan servicer identifier would be a name such as “XYZ Bank”, or perhaps a more precise unique identity number from a directory of loan servicers. Examples of a loan account identifier would be an account number, or a debtor name, or a property address of any property used for collateral, or a combination of such identifiers. It is anything the loan servicer can use to identify a loan account.

In this embodiment of the present invention the user inputs a fax number for the loan servicer, as shown at 309. Therefore the loan servicer identifier inputted at 306, such as “XYZ Bank” need not be exact, and could be entered, for example, as “XYZ Bank Inc”.

At 312 the input information is stored. At this point, the user is able to log off. It should be understood that loan servicing companies often take several days or more to process requests for payoff-statements. Therefore in this embodiment, the user can log off at 315, with the intention of logging back on later. At 318, the central controller builds the request document using “canned” wording and at 321 adds the return fax number. This is the fax number to which the loan servicer is instructed to send its reply. In this embodiment, this number points to the fax-to-email service 255. At 324, a unique identity number (request ID) is generated for the request and embedded in the request document as shown in FIG. 4 at 425c. This unique id is wrapped in text substrings that will allow it to be extracted later from the OCR-generated text that will be found in reply payoff-statement 240. At 327, the information regarding the request document is stored in database 230b.

At 330, the central controller emails request document 235 to email-to-fax service 250, and at 333, the email is received. (An example of this email-to-fax service, sometimes called a fax-sending service, is MAXEMAIL, a product of Integrated Global Concepts, Inc. Other examples are INNOPORT, by Intellicomm Inc., and VILLAGEFAX.NET by VillageEDOCS Corp. At 336, the email-to-fax service converts the email to a fax which it then faxes to the loan servicer. At 339, the loan servicer receives the fax and at 342, creates payoff-statement 275, which often takes several days, but could occur immediately. At 345 the loan servicer faxes the reply to the fax number specified in the request, which is the fax number of fax-to-email service 255. Examples of a fax-to-email service, sometimes called a fax-receive service, are THRUFAX, by Onset Technology, Inc, or JFAX, by J2 Global Communications, Inc. At 348, the fax-to-email service receives the fax, and at 351, generates text from the fax image using OCR (optical character recognition). At 354, the fax-to-email service sends an email to central controller 200. In an embodiment using THRUFAX, the body of the email contains the OCR-generated text and the fax image is attached to the email as a tiff file. In another embodiment, using JFAX, the fax-to-email service sends an email containing a single .pdf (Adobe Portable Document Format) file containing both OCR generated text and an image, this file type being known as a PDF Searchable Image document. In yet another alternative embodiment, the OCR is performed by controller 200 rather than at the fax-to-email service, using OCR software on the controller, such as MICROSOFT OFFICE DOCUMENT IMAGING, or MICROSOFT WINDOWS 2000 FAX SERVICE, or SCANSOFT SDK.

At 357, central controller 200 receives the email, and at 360, stores it. At 363, the central controller extracts the request ID from the OCR-generated text, and at 366, uses that request ID to associate the reply with its particular causative request.

This association enables the controller to lookup the user's email address stored in database 230a, and at 369, the controller sends an email alert to the user, stating that a payoff-statement has been received and is available for viewing. At 372, the user receives the email, and at 375, logs onto the central controller 200 via interface 210. At 378, the central controller displays the request to the user, and at 381, displays the payoff-statement to the user as an image in the user's browser. At 383 the method ends.

Note: Electronic Address Lookup

In another embodiment, the need for the user to input the loan servicer fax number at 306 is obviated by central controller 200 instead receiving this input by looking up the fax number in a database directory of loan servicers with their electronic network addresses stored in storage 230f, based on the inputted loan service identifier. In yet another embodiment, the central controller receives the loan servicer fax number by looking it up via the Internet in an external database directory of loan servicers, such as a bank directory.

Discussion of FIG. 4

This section discusses FIG. 4, but in conjunction with FIG. 2. Item 410 is a segment of a conventional payoff-statement request. Item 420 shows the segment with a request ID embedded in the attention phrase, comprising substrings 425a, 425b, 425c, and 425d. The purpose here is to somehow insinuate the request ID into the payoff-statement eventually produced by loan servicer 280, so that when central controller 200 eventually receives the payoff-statement, it can associate it with its causative request. Since most conventional loan servicers don't have a request ID field in their payoff-statements, a surrogate field is chosen, for example the “Attn” field, in order to “trick” the loan servicer into passing on the request ID into the payoff-statement. Substrings 425b and 425d are used as delimiters so that after payoff-statement 275 is OCR'd by fax-to-email service 255, controller 200 can search the OCR-generated text in payoff statement 240 looking for the delimiters, and extract the request ID 425c located between them. Fax number 428 directs the loan servicer to send payoff-statement 275 to fax-to-email service 255.

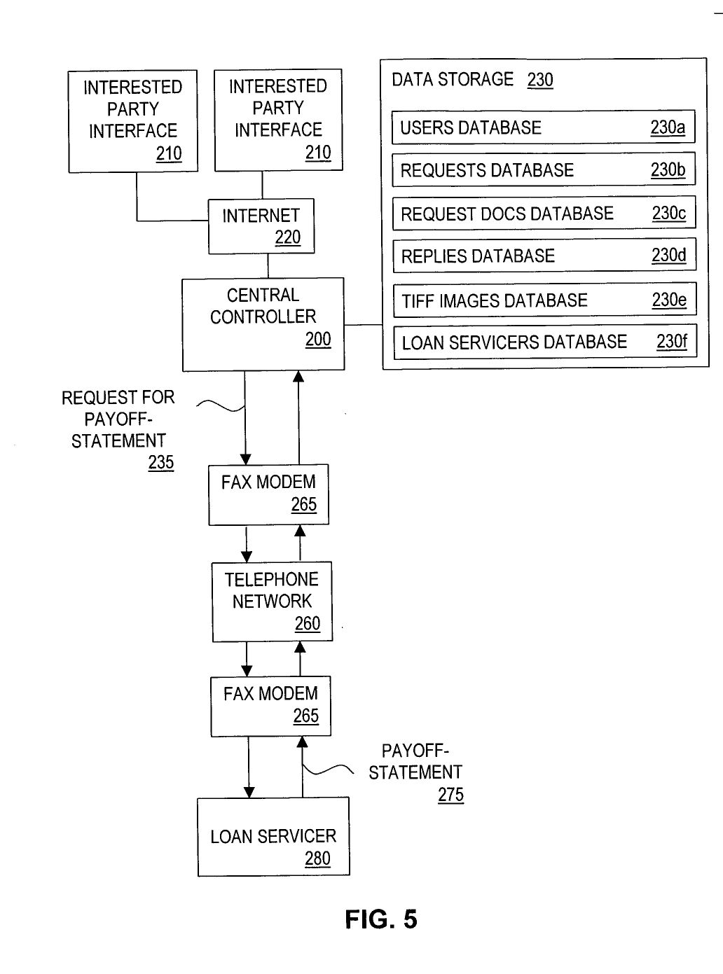

Discussion of FIG. 5

Another apparatus embodying the present invention is illustrated in FIG. 5. This apparatus is substantially the same as the apparatus illustrated in FIG. 2, except that the apparatus of FIG. 5 has an additional fax modem 265 in place of FIG. 2's email-to-fax service 250 and fax-to-email service 255. The embodiment in FIG. 5 also differs from the embodiment in FIG. 2 in that central controller 200 is furthermore executing a fax program, for example, WINDOWS 2000 PLATFORM SDK FAX SERVICE by Microsoft, or WINFAX by Symantec, and a program that utilizes and manipulates OCR commands, for example those available in OFFICE XP DOCUMENT IMAGING by Microsoft, or WINDOWS 2000 PLATFORM SDK FAX SERVICE by Microsoft, or OMNIPAGE or SCANSOFT SDK, both by ScanSoft, Inc.

In the embodiment illustrated in FIG. 5, central controller 200 transmits request 235 by fax modem 265 rather than by email, and upon receipt of incoming fax payoff-statement 275, performs OCR (optical character recognition) on the fax image file and extracts text. Then the central controller extracts the request ID from the text in the same manner as illustrated in FIG. 4.

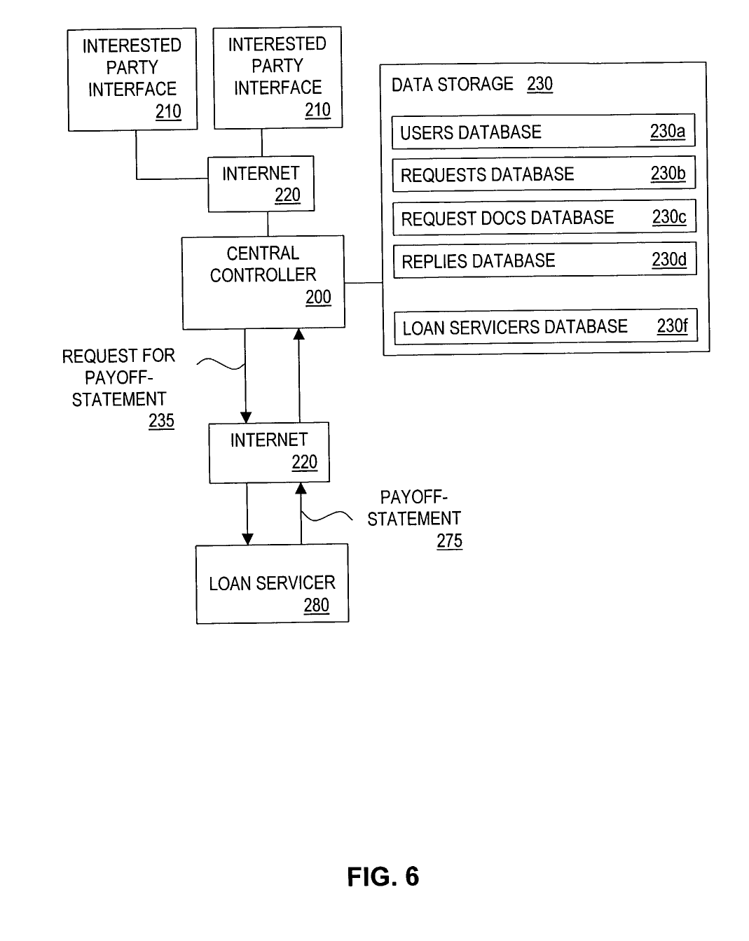

Discussion of FIG. 6

Yet another system constructed in accordance with an embodiment of the present invention is illustrated in FIG. 6. This embodiment is substantially identical to the embodiment in FIG. 2, except for the following. In this embodiment, request 235 is transmitted over network 220 directly to loan servicer 280 using an Internet URL (Uniform Resource Locator) as the electronic address of loan servicer 280. Here, request 235 is in the form of an XML (Extensible Markup Language) formatted electronic message, with a dedicated request ID field. XML enables the data in the request document to be self-describing and to be read by heterogeneous computing platforms, thus enhancing transmission. This embodiment requires pre-coordination and agreement with the loan servicer for a common XML format for payoff statement requests and replies. It is received by loan servicer 280, which in this embodiment is a computer, and processed. The loan servicer then transmits reply payoff-statement 275, in the form of XML formatted electronic message, directly to central controller 200, via the Internet. Central controller 200 then directly reads the XML formatted data in reply 275 directly, without need of OCR, extracts a request ID directly, without need of coded delimiters, and stores the reply data in replies database 230d. The central controller then associates the extracted request ID with a record in requests database 230b, and looks up the email address of the user who created the request. Then, using the data extracted from the XML, and an XSL (Extensible Stylesheet Language) style sheet transformation, the central controller builds a user-friendly payoff-statement document, which it sends by email to the user. The user is also enabled to log onto the central controller at that point to view the reply in the context of the request history also displayed by the central controller. Note that in FIG. 6, there is no need for the tiff images database 230e found in FIG. 2.

In one embodiment of FIG. 6, central controller 200 is operating as a Web Service. The term Web Service can be generally defined as a computer procedure (or procedures) that can be invoked remotely over the Internet using SOAP (Simple Object Access Protocol). An additional advantage is that the SOAP protocol is built upon XML (Extensible Markup Language), which facilitates the exchange of structured data between dissimilar computing platforms. The central controller, operating as a Web Service, (a) accepts a payoff-statement request as a SOAP procedure call via the Internet from a computer at a remote escrow company, and processes it, (b) makes a SOAP procedure call, containing and XML payoff-statement request, via the Internet to a computer at the loan servicer, (c) accepts a return XML message via the Internet from the loan servicer computer, and processes it, and finally (d) sends the end result back to the requesting escrow company computer.

In yet another embodiment, a similar process takes place, furthermore using message queuing techniques, such as those used in e-commerce applications developed with platforms such as MICROSOFT BIZTALK SERVER, to automatically manage the asynchronous nature of processing between different work groups.

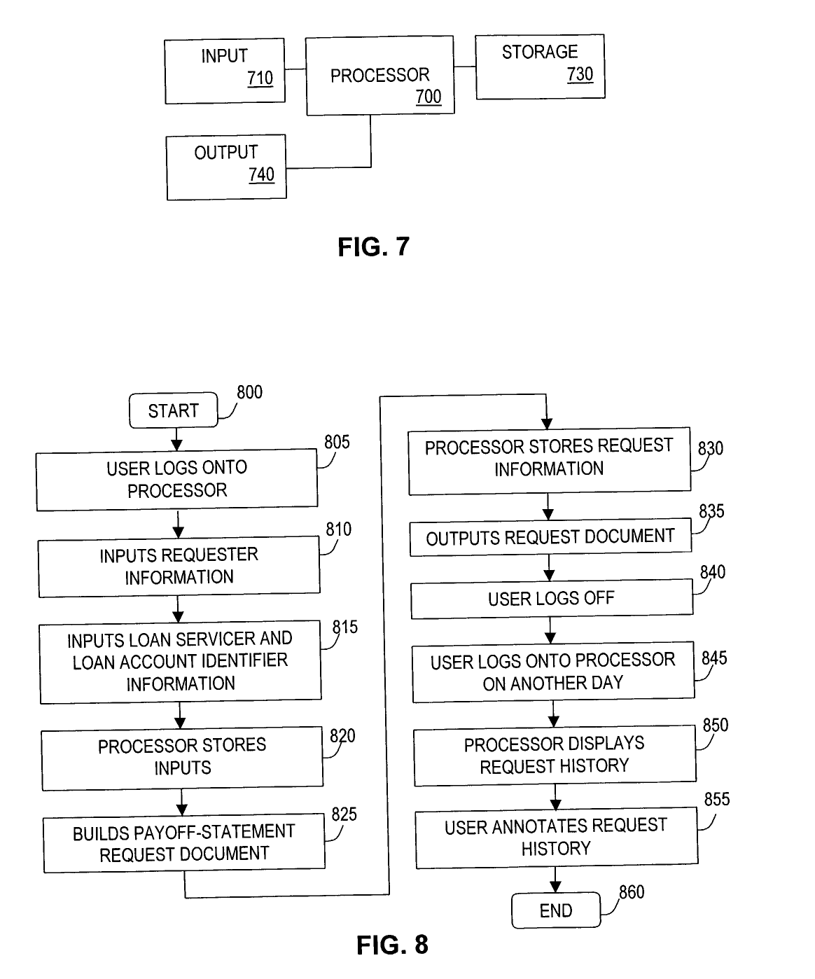

Discussion of FIGS. 7 and 8

An apparatus constructed in accordance with an embodiment of the present invention is schematically shown in FIG. 7. This embodiment differs from previously discussed embodiments in that this particular apparatus is a stand-alone computer not connected to a network.

This is a stand-alone computer for the building, storing and outputting and management of payoff-statement requests. It is well suited, though not specifically, for an escrow office or loan originator not connected to the Internet.

In this embodiment, output component 740 is capable of outputting to a video display and to a printer. Input component 710 is capable of receiving input from a keyboard and a mouse. Processor 700 is a CPU (Central Processing Unit) or conventional computer operatively connected with input 710, with storage 730, and with output 740. Data storage 730 is substantially similar to data storage 230 of FIG. 2, but without the tiff images database.

FIG. 8 illustrates an embodiment of the present invention as a method for using the apparatus of FIG. 7. The method may be seen to begin at 800. At 805, the user logs onto processor 700 via input 710, and at 810, inputs requester information, for example the name, company, phone number, and fax number of a requesting escrow agent. At 815 the user inputs the name of a loan servicer, for example “XYZ Bank”, the loan servicer's fax number or other address, and a loan account identifier, for example “987-87654-76543”. At 820, processor 700 stores the inputs in storage 730. At 825, the processor builds a payoff-statement request document based on the inputs. At 830, a record of the built request is also stored in storage 730. At 840, the processor prints a copy of the request document via output 740. This printed paper document is meant to be faxed by the user using an independent conventional fax machine, or even sent by mail or express delivery.

At 840, the user logs off. Since it takes several days or more for many loan servicers to process requests for payoff-statements, the user logs onto the processor on another day at 845. The processor retrieves a list of requests from storage 730 and displays it to the user via output 740. The user examines this list and the request of interest. If at this point the user has received a reply from the loan servicer (via a conventional fax machine, or by postal mail or express delivery, for example), the user annotates the request record showing that the reply was successfully received. When a reply has not been received by the user yet, the processor displays the record so that the user is able determine when the request was created, what it looked like, and where exactly it was faxed or sent to, enabling the user to follow-up. The processor also enables the user to conveniently re-create a new request from the old request in situations where, for example, the escrow closing date has been postponed and new payoff figures are needed.

Furthermore, over a period of time, as the user sends request after request, the processor accumulates to storage 730 all the various inputted loan servicer identifiers with their inputted fax numbers, so that after awhile, a user can conveniently lookup fax numbers or other addresses of loan servicers. In another embodiment of the present invention, a pre-built directory of loan servicers with their electronic addresses is provided in storage 730.

In addition, an embodiment of the invention enables the user to sort, group and count the records in a request history, and print summary reports of request details for requests created during a given time interval such as month, quarter or year. The process of FIG. 8 can be seen ending at 860.

Note: Electronic Address Lookup

In another embodiment, the need for the user to input the loan servicer fax number or other address at 815 is obviated by the processor instead receiving this input by looking up the fax number or address in a database directory of loan servicers with their addresses stored in storage 730.

Discussion of Computer Program Listing Appendix

Following is information pertinent to usage of the code in the “computer program listing appendix” that was incorporated into this document near the beginning of the Specification, just after the Title of the invention. It is helpful to consider this discussion in conjunction with FIG. 2, FIG. 3(a) and FIG. 3(b) and with variations and modifications as would be known by those skilled in the art.

The main computer programming languages used include ASP.NET, VB.NET, ADO.NET, JavaScript, and SQL.

Those skilled in the art will recognize that the present invention is not limited to the representative examples disclosed here.

Controller Environment:

Hardware:

Conventional Computer, Sager NP3360 (or Dell or Compaq)

Intel Pentium III Processor

256 MB SDRAM

20 GB Hard drive

Software:

Microsoft Windows 2000 Professional

Microsoft Office XP

Microsoft Internet Explorer 6.0

Microsoft Outlook 2002

Configuration:

Display a notification message when new mail arrives=false

Schedule an automatic send/receive every 5 minutes=true

Microsoft Internet Information Server 5.0

Microsoft SQL Server 2000

Microsoft NET Framework

Microsoft Visual Studio.NET 1.0

Client Environment:

Hardware:

Conventional Computer: Sager NP3360 (or Dell or Compaq)

Intel Pentium III

256 MB SDRAM

20 GB Hard drive

Software:

Microsoft Windows 2000 Professional

Microsoft Office XP

Microsoft Internet Explorer 6.0

Microsoft Outlook 2002

All software and hardware with default configurations, except where otherwise stated, or as would be known to those skilled in the art.

Guide for SQL Server Database

Proceed as one skilled in the art and per the drawings, computer program listing, and methods described in this discussion heretofore.

A table storing the payoff-statement replies may be referred to as “replies” table or, in some circumstances, more usefully referred to as “in-faxes” table because the replies take the form of incoming faxes. Likewise a table storing tiff images might be referred to as “tiff images” table, or, sometimes more usefully as “in-fax images” table. Based on the drawings and the discussion heretofore, other table details will be apparent to those skilled in the art.

An embodiment of the present invention uses a table structure like this:

Table tblUsers has fields such as UserId, CreationTime, CreatorUserId, AccountId, SessionIdAtCreation, Email, EmailAtCreation, Password, FirstName, LastName, LHFullName, LHTitle, LHCompany, LHAddress, LHCity, LHState, LHZip, LHPhone, IsAccountSuper, IsAccountMgr, ActivationCode, Activated, ActivationTime, LastEditByUserTime, LastEditByUserId, and DenyAllRights.

Table tblClosings has fields such as ClosingId, CreationTime, CreatorUserId, AgentUserId, EscrowId, CustomerLastName, IdNewLoan, ExpectedClosingDate, ExpectedPayoffDate, and NoteHist.

Table tblLoans has fields such as LoanId, CreationTime, CreatorUserId, ClosingId, LenderLooseName, LoanNum, RecordingDate, RecordingSerial, and RequestFax.

Table tblLoanBorrowerLinks has fields such as LinkId, CreationTime, CreatorUserId, LoanId, and BorrowerId.

Table tblLoanPropLinks has fields such as LinkId, CreationTime, CreatorUserId, LoanId, and PropId.

Table tblRequests has fields such as RequestId, CreationTime, CreatorUserId, LoanId, ReturnFax, ReturnAttnPhrase, ServicerId (historical), Loan_LoanNum, Loan_LenderLooseName, Loan_PDSRequestFax, Closing_EscrowId, and User_LHFullName.

Table tblRequestDocs has fields such as RequestDocId, CreationTime, RequestId, and Html.

Table tblInFaxes (Replies) has fields such as InFaxId, CreationTime, CreatorUserId, TestForeignId, TestBoolean, EmailSender, EmailRecipient, EmailSubject, EmailBody, AttachFileNameDoc, AttachFileNameTif, Tiffmage, RequestId_OCR, RequestId-Manual, RequestId_Use, LoanNum_OCR, LoanNum_Manual, EscrowId_OCR, EscrowId_Manual, PropertyAddr_OCR, and PropertyAddr_Manual.

Table tblInFaxImages (TiffImages) has fields such as InFaxImageId, CreationTime, CreatorUserId, InFaxId, AttachFileNameTif, and TifImage.

Table tblBorrowers has fields such as BorrowerId, CreationTime, CreatorUserId, ClosingId, LoanId (via link), LastName, FirstName, and SSN.

Table tblProps (Properties) has fieIds such as PropId, CreationTime, CreatorUserId, ClosingId, LoanId (via link), PropAddress, PropCity, PropState, PropZip, and LegalDescription.

Table tblServicers has fields such as ServicerId, CreationTime, CreatorUserId, ParentCompanyId, LongCompanyName, RequestFax, and RequestEmail.

Table tblWbLg_SessionLogs has fields such as SessionLogId, CreationTime, SessionId, UserId, BrowserType, BrowserIsAOL, BrdwserIsCrawler, BrowserPlatform, SupportsCookies, SupportsJavaScript, Url, UrlPage, UrlReferrer, UrlReferrerPage, UserHostAddress, UserHostName, HistFirstName, HistLastName, HistEmail, and HistPassword.

Table tblWbLg_PointLogs has fields such as PointLogId, CreationTime, SessionId, SessionLogId, Reference, AttributeName, AttributeValue, Url, UrlReferrer, UrlReferrerPage, LocalLevel, and AppSettingLevel.

SQL Server stored procedures are included in “computer program listing appendix”.

Guide for Windows application WinAppRout

Proceed as one skilled in the art and per the drawings, computer program listing, and methods described in this discussion heretofore.

In Visual Studio.NET, make a new WinForm application called WinAppRout.

Load WinAppRout files defined in “computer program listing appendix” into Visual Studio.NET and use Build command to build WinAppRout.exe. See project definition in listing.

Run Outlook 2002.

Run WinAppRout.exe.

In WinAppRout, choose frmInFaxTool, then invoke button Start Auto-Pilot.

Guide for making web application WebAppPA server-side

Proceed as one skilled in the art and per the drawings, computer program listing, and methods described herein.

In Visual Studio.NET, make new Web application called WebAppPA.

Load WebAppRout files defined in “computer program listing appendix” into Visual Studio, and use Build command to build. Then deploy the web application. See project definition in listing.

Guide for using WebAppPA client-side

Proceed as one skilled in the art and per the drawings, computer program listing, and methods described herein.

In Internet Explorer, navigate to the deployed web application. Choose MyWork, AllClosings, then click Plus button. Follow screens.

Conclusions, Ramifications, and Scope

The present invention provides not only a stand-alone computer solution to the need for a way to conveniently create, store, print and manage payoff-statement requests. In addition, it provides an efficient solution to the important need to interface electronically with the loan servicing industry's entrenched fax-based system. It also provides a way for multiple interested parties to share time-sensitive payoff-statement information.

In addition, it provides a means for enhanced transmission of both payoff-statement requests and payoff-statements, using XML (Extensible Markup Language) and a Web Service. Furthermore, the present invention provides a core for sharing real estate transaction management information among a plurality of parties that have a joint interest in a pending real estate transaction, for example, a buyer, a seller, a real estate broker, an attorney, an appraiser, an escrow agent, a title insurance agent, and other interested parties. In the present invention, a set of Web Services, one acting on behalf of each of the parties just mentioned, can interface with the core web service, thus extending the efficiencies of the invention outward to other automated systems.

Those skilled in the art will recognize that the method and apparatus of the present invention has many applications, and that the present invention is not limited to the representative examples disclosed herein. Moreover, the scope of the present invention covers conventionally known variations and modifications to the system components described herein, as would be known by those skilled in the art.

I claim:

1. An apparatus for facilitating acquisition of prospective payoff information on an existing loan account, comprising:
an input device;
an output device;
a storage device;
a processor connected to the input device, to the output device, and to the storage device storing a program for controlling the processor; the processor being operative with the program to
receive information identifying a requester;
receive information identifying a loan servicer, including an electronic address;
receive information identifying a loan account;
build a payoff-statement request document based on the received information;
store information regarding the request document; and
output the request document.

2. The apparatus of claim 1 wherein the input device is a network interface connector.

3. The apparatus of claim 1 wherein the input device is a keyboard.

4. The apparatus of claim 1 wherein the output device is a video display.

5. The apparatus of claim 1 wherein the output device is a printer.

6. The apparatus of claim 1 wherein the output device is a fax modem.

7. The apparatus of claim 1 wherein the output device is a network interface connector.

8. The apparatus of claim 1 wherein the payoff-statement request document is electronic.

9. The apparatus of claim 1 wherein the processor is operative with the program to receive the loan servicer electronic address by looking it up in a directory of loan servicers.

10. The apparatus of claim 1, the processor furthermore being operative with the program to transmit the payoff-statement request document to the loan servicer via the electronic address.

11. The apparatus of claim 10 wherein the electronic address of the loan servicer is a fax number.

12. The apparatus of claim 10 wherein the electronic address of the loan servicer is an internet uniform resource locator.

13. The apparatus of claim 10 wherein the inputted electronic address of the loan servicer is received from an directory of loan servicers and their electronic addresses.

14. The apparatus of claim 10 wherein the processor is operative with the program to accumulate a directory of loan servicers and their electronic addresses.

15. The apparatus of claim 10, the processor furthermore being operative with the program to receive from the loan servicer a resultant payoff-statement in reply to the transmitted payoff-statement request, and to output said payoff-statement.

16. The apparatus of claim 15 wherein the processor is operative with the program to act as a web service.

17. A method for using a computer to facilitate acquisition of prospective payoff information on an existing loan account, comprising the steps of:
inputting into the computer information identifying a requester;
inputting into the computer information identifying a loan servicer;
inputting into the computer information identifying a loan account;
building a payoff-statement request document for transmittance to the loan servicer;
storing a record regarding the payoff-statement request document;
outputting the payoff-statement request document; and
providing access to the record regarding the payoff-statement request document.

18. The method of claim 17 wherein the outputted payoff-statement request document is electronic.

19. The method of claim 17 wherein the user is another computer.

20. The method of claim 17 furthermore inputting into the computer an electronic network address of the loan servicer, and furthermore transmitting the payoff-statement request document to the loan servicer via an electronic network.

21. The method of claim 20 wherein the transmittance is performed over the conventional telephone network by facsimile.

22. The method of claim 20 wherein the transmittance is performed using an email-to-fax service.

23. The method of claim 20 wherein the electronic network is the Internet.

24. The method of claim 20 wherein the payoff-statement request document is built using an extensible markup language structure to provide enhanced data transmission.

25. The method of claim 20 furthermore providing an electronic directory of loan servicers with their electronic network addresses as a means for inputting the electronic network address of the loan servicer.

26. The method of claim 20 furthermore providing reception of a reply payoff-statement document from the loan servicer.

27. The method of claim 26 wherein the reply payoff-statement reception is performed over the conventional telephone network by facsimile.

28. The method of claim 26 wherein the reply payoff-statement reception is performed using a fax-to-email service.

29. The method of claim 26 wherein the request is sent as a simple object access protocol invocation of a web service at the loan servicer.

30. The method of claim 26 furthermore providing accumulation, of the loan servicer electronic address in the reply's associated request, to a directory of loan servicers and their confirmed electronic addresses, upon successful reception of the reply.

31. The method of claim 26 furthermore providing access for a plurality of users to the payoff-statement.

32. A method for associating a payoff-statement received from a loan servicer with a causative payoff-statement request, comprising:
embedding a unique identifier into a surrogate field of a payoff-statement request as to make it likely that the unique identifier will become embedded in a resultant payoff-statement generated by a loan servicer in reply to the request; and
extracting the unique identifier from the reply payoff-statement after receiving the reply payoff-statement from the loan servicer.

33. The method of claim 32 wherein the unique identifier is embedded into an attention field of the payoff-statement request.
